(19) United States
(12) Patent Application Publication
(10) Pub. No.: US 2024/0028400 A1
(43) Pub. Date: Jan. 25, 2024

(54) MEMORY BANDWIDTH ALLOCATION IN MULTI-ENTITY SYSTEMS

(71) Applicant: NVIDIA Corporation, Santa Clara, CA (US)

(72) Inventors: Gaspar Mora Porta, Campbell, CA (US); Blaise Fanning, Folsom, CA (US); Michael Allen Parker, San Jose, CA (US); Manikandan Chandrasekaran, Bengaluru (IN); Adarsha Rao S J, Bangalore (IN); Raghuram L, Bangalore (IN)

(21) Appl. No.: 17/872,621

(22) Filed: Jul. 25, 2022

(51) Int. Cl. G06F 9/50; G06F 9/46

(52) U.S. Cl. CPC G06F 9/5016; G06F 9/5044; G06F 9/467

(57) ABSTRACT

In various examples, a transaction type of a transaction from a processing resource of a plurality of processing resources sharing a bus may be determined and used to track bandwidth usage for the processing resource with respect to a time slot. Transactions that indicate usage of downstream bandwidth may be distinguished from transactions that do not indicate usage of downstream bandwidth. Bandwidth usage for a time slot may be tracked using one or more counters. The system may block or permit transactions from reaching the bus based at least on the counter exceeding a threshold value. The total allocation of bandwidth to the processing resources sharing a bus may be limited to a value that is less than a maximum capability of the bus to allow for headroom. Bandwidth coming from different lines and/or lanes and belonging to the same processing resource may be shared.

### BACKGROUND

Some graphics processing unit (GPU) chips include features that allow a Cloud Service Provider to split the chip hardware into independently operated regions that behave as independent (smaller) GPUs (partitions). Cloud Service Providers may use the extra level of granularity from these features to provide partitions of different sizes to different tenants, so chip use can be increased. It may be critical that applications executing on a partition behave the same irrespective of what resources other tenants or partitions are consuming. This can be achieved with guarantees of partition isolation architected into the chip. Various mechanisms have been implemented to enhance isolation in partition processing performance. However, there are a lack of features for isolating partition memory bandwidth amongst a shared interface, such as for peripheral component interconnect express (PCIe). As such, one partition may encounter inconsistent or degraded memory bandwidth depending on whether other partitions and/or other entities are consuming memory bandwidth over the interface.

Conventional approaches for allocating memory bandwidth to partitions have enforced caps for a partition on the number of transactions that may be issued over time. While this approach may limit the upstream bandwidth usage of a partition, certain transactions, such as read requests and atomic operations, may result in larger downstream bandwidth usage that can impact the downstream resources available to other partitions. For example, a read request may be relatively small, such that many may be issued from a partition over a period of time. However, responses to the requests may include much larger chunks of data read from memory. Additionally, conventional approaches fail to account for the impact of incoming traffic to a partition that is initiated by another entity, which can consume bandwidth at the expense of other partitions.

### SUMMARY

Embodiments of the present disclosure relate memory bandwidth allocation in multi-entity systems. More specifically, the disclosure relates to approaches for tracking and enforcing allocation of bandwidth to processing resources over one or more shared buses. In one or more embodiments, the consistency in bandwidth that may be used by a processing resource can be improved whether or not other entities are transmitting data over the shared bus(es).

In contrast to conventional approaches, such as those described above, disclosed approaches may determine a transaction type of a transaction from one or more processing resources of a plurality of processing resources sharing one or more buses and track bandwidth usage for the one or more processing resources with respect to a time slot based at least on the transaction type. In at least one embodiment, transactions that indicate usage of downstream bandwidth may be distinguished from transactions that do not indicate usage of downstream bandwidth to provide more consistent downstream bandwidth for the processing resources. Bandwidth usage for a time slot may be tracked using one or more counters. The system may block or permit transactions from reaching the one or more buses based at least on the counter exceeding a threshold value. In further respects, a transaction monitor(s) may account for at least a portion of traffic from (e.g., initiated by) a computer component to a processing resource in filtering and/or enforcing the outbound or upstream traffic from the processing resource. Additionally, the total allocation of bandwidth to the processing resources sharing a bus may be limited to a value that is less than a maximum capability of the bus to allow for headroom. Further aspects of the disclosure provide for sharing bandwidth coming from different lines and/or lanes belonging to the same processing resource.

### BRIEF DESCRIPTION OF THE DRAWINGS

The present systems and methods for memory bandwidth allocation in multi-entity systems are described in detail below with reference to the attached drawing figures, wherein:

FIG. 1 depicts an example of a bandwidth allocation system, in accordance with some embodiments of the present disclosure;

FIG. 2 illustrates an example of upstream and downstream bandwidth allocations for a plurality of processing resources, in accordance with some embodiments of the present disclosure;

FIG. 3A illustrates examples of amounts of bandwidth usage for various transactions, in accordance with some embodiments of the present disclosure;

FIG. 3B illustrates an example of upstream and downstream bandwidth usage for a transaction corresponding to FIG. 3A, in accordance with some embodiments of the present disclosure;

FIG. 4 is an illustration of an example of a transaction pipeline that may be used for enforcing a bandwidth allocation to one or more processing resources, in accordance with some embodiments of the present disclosure;

FIG. 5A is an illustration of an example of a logic diagram which may be implemented to enforce bandwidth allocation for one or more processing resources, in accordance with some embodiments of the present disclosure;

FIG. 5B is an illustration of an example of a logic diagram which may be implemented to enforce bandwidth allocation for one or more processing resources across a plurality of send and/or receive lines, in accordance with some embodiments of the present disclosure;

FIG. 6 is a flow diagram showing a method for enforcing a bandwidth allocation for a processing resource based on a transaction type, in accordance with some embodiments of the present disclosure;

FIG. 7 is a flow diagram showing a method for enforcing a bandwidth allocation for a processing resource based on a transaction indicating usage of downstream bandwidth, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

The present disclosure relates to memory bandwidth allocation in multi-entity systems. More specifically, the disclosure relates to approaches for tracking and enforcing allocation of bandwidth to processing resources over one or more shared buses. In one or more embodiments, the consistency in bandwidth that may be used by a processing resource can be improved whether or not other entities are transmitting data over the shared bus(es).

In contrast to conventional approaches, such as those described above, disclosed approaches may determine a transaction type of a transaction from one or more processing resources of a plurality of processing resources sharing one or more buses and track bandwidth usage for the one or more processing resources with respect to a time slot based at least on the transaction type. Thus, disclosed systems may account for various features of the transaction to provide a more consistent enforcement and allocation of bandwidth for processing resources. For example, disclosed approaches may account for the impact of a transaction on upstream and/or downstream traffic over the one or more buses for the time slot.

In at least one embodiment, transactions that indicate usage of downstream bandwidth, such as reads and atomics, may be distinguished from transactions that do not indicate usage of downstream bandwidth, such as writes. Using disclosed approaches, the number of transactions that indicate usage of downstream bandwidth and may be included in a time slot may be limited for the time slot, providing more consistent downstream bandwidth for the processing resources. For example, a read transaction may be blocked from a time slot even where the time slot includes space for the read transaction based at least on a bandwidth allocation being exceeded and/or determining the transaction would cause the bandwidth allocation to be exceeded.

In at least one embodiment, bandwidth usage for a time slot may be tracked using one or more counters. The one or more counters may be used to enforce an amount of bandwidth allocated to the one or more processing resources over the one or more buses for a time slot. For example, a counter may be updated based at least on a transaction being of a transaction type and/or indicating usage of downstream bandwidth. The system may block or permit transactions from reaching the one or more buses based at least on the counter exceeding a threshold value.

In at least one embodiment, the counter(s) for a processing resource may be reset for each time slot. In various embodiments, the threshold value(s) (or counter value(s)) may be used to enforce a hard or soft cap on the transactions which may be included in a time slot. For example, for a hard cap, a transaction may be excluded from the timeslot based at least on a threshold value being exceeded, and a corresponding threshold value (and/or counter value) may be reset to the same value as the prior time slot. For a soft cap, a transaction may be included in a timeslot where the threshold value is exceeded, and a corresponding threshold value (and/or counter value) may be increased or decreased to compensate for the additional transaction. Similarly, in one or more embodiments, excess bandwidth for a time slot may be carried over to a subsequent time slot(s) through adjustment to the threshold value (and/or counter value).

In further respects, a transaction monitor(s) may be used to limit outbound or upstream traffic, which may be from a processing resource(s). In at least one embodiment, the transaction monitor(s) may account for at least a portion of traffic from (e.g., initiated by) a computer component to a processing resource in filtering and/or enforcing the outbound or upstream traffic from the processing resource. For example, the threshold(s) (and/or counter value(s)) may be adjusted (e.g., decreased) based at least on the inbound traffic. In one or more embodiments, the inbound traffic may count, at least in part, as outbound and/or inbound traffic generated by the processing resource. Additionally or alternatively, the inbound traffic may be used to credit, at least in part, outbound and/or inbound traffic that can be generated by or provided to one or more other processing resources.

In further respects, the total allocation of bandwidth to the processing resources sharing a bus(es) may be limited to a value that is less than a maximum capability of the bus(es). Doing so may allow for headroom to account for other entities using the bus(es). For example, the remaining bandwidth may be used for background interactions with the host device, and/or may be used to account for inconsistencies in the maximum capability of the bus(es). The total allocation may be updated dynamically or may be constant throughout operation of the processing resources.

Further aspects of the disclosure provide for sharing bandwidth coming from different lines and/or lanes belonging to the same processing resource. For example, a single processing resource may use more than one line and/or lane so as to be capable of consuming the bandwidth allocation from all of its lines and/or lanes, even where only one line and/or lane is used. To do so, disclosed approaches may account for transactions from one or more other transaction pipelines when monitoring bandwidth for a transaction pipeline.

The systems and methods described herein may be used for a variety of purposes, by way of example and without limitation, these purposes may include systems or applications for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, digital twin systems, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

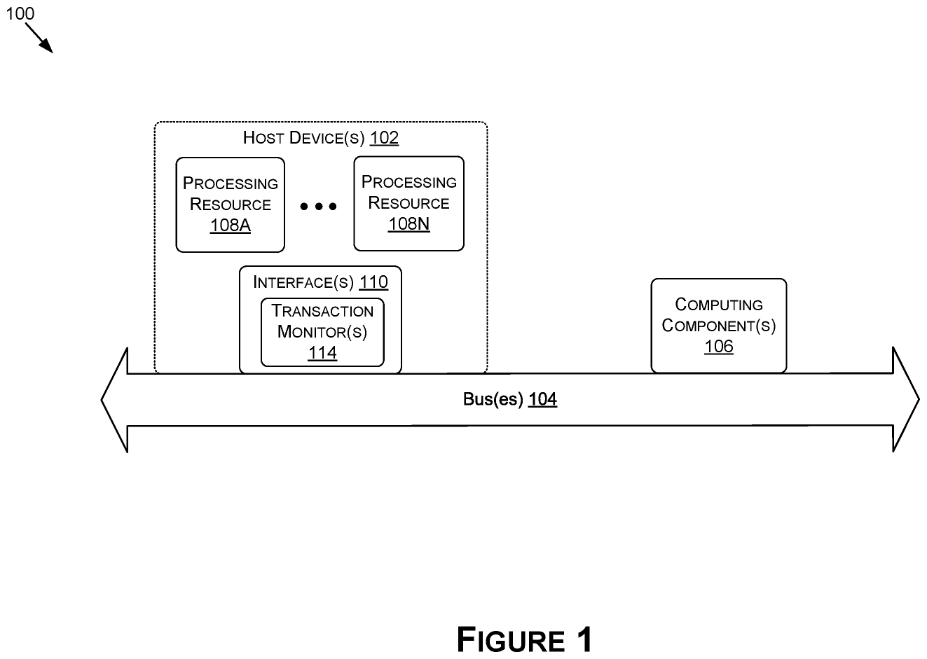

FIG. 1 depicts an example of a bandwidth allocation system 100 (also referred to herein as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 may be implemented using, among other components, one or more host devices, 102, one or more buses 104, and one or more computing components 106. The one or more host devices 102 may include one or more processing resources, such as processing resources 108A through 108N (also referred to as “processing resources 108”), and one or more interfaces 110 to the one or more buses 104. As shown, the interface(s) 110 may include a transaction monitor(s) 114. While shown in the interfaces 110, in at least one embodiment, one or more features or aspects of functionality of the transaction monitor(s) 114 may be implemented at least partially elsewhere in the system 100, in addition to or alternatively from the interface(s) 110.

As an overview, the host device(s) 102 (e.g., a GPU) may host one or more processing resources (e.g., partitions), such as the processing resources 108. The host device 102 may further include the interface 110 (e.g., a PCIe interface) to the bus 104 (e.g., a memory bus), which may be shared by one or more of the processing resources 108. For example, the processing resources 108 may send data corresponding to transactions over the bus 104 to the computing component(s) 106 (e.g., a CPU) using the interface 110 and/or receive data corresponding to transactions over the bus 104 from the computing component(s) 106 using the interface 110. The transaction monitor(s) 114 may be configured to analyze the data corresponding to the transactions for the processing resources 108 based on corresponding bandwidth allocations, so as to control the data on the bus 104.

As described herein, the host devices 102 may include one or more GPUs, one or more CPUs, one or more systems on chips (SoCs), one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The computing components 106 may include one or more devices similar to or different than the host devices 102. Further, the computing components 106 may include any computing components capable of sending and/or receiving transaction data using the bus(es) 104. As further non-limiting examples, the computing components 106 may include one or more caches, one or more random access memories (RAMs), such as dynamic RAM (DRAM), one or more peripheral devices, etc. The buses 104 may include any number of pathways used to transfer data between components inside a computing system, between computing systems, and/or between computing devices or components. Examples include one or more memory buses, internal buses, external buses, address buses, system buses, timing buses, data sharing buses, and/or I/O buses.

The interfaces 110 may include one or more hardware interfaces to the bus(es) 104, such as, but not limited to, one or more PCIe interfaces, a PCI interfaces, device-to-device interfaces, such as NVlink or inter-chip global memory interconnect (xGMI) interfaces, accelerated graphics port (AGP) interfaces, PCI eXtended (PCI-X) interfaces, industry standard architecture (ISA) interfaces, extended ISA (EISA) interfaces, micro channel architecture interfaces (MCA), video electronics standards association (VESA) interfaces, personal computer memory card industry association (PCMCIA or PC bus) interfaces, small computer systems interfaces (SCSI), and/or universal serial bus (USB) interfaces.

The processing resources 108 may refer to a physical or virtual processing component of limited availability within the system 100 in at least one embodiment, a processing resource 108 may correspond to respective one or more partitions, processes, and/or services of a host device 102, or may correspond more generally to a respective host device 102. For example, the processing resource 108A may correspond to a partition of a GPU, a CPU, and/or another processing device or processing unit. By way of example and not limitation, the processing resource 108A may include a Multi-Instance Gal (MEG).

In at least one embodiment, the processing resources 108 may correspond to multiple instances of the host device 102, each fully isolated with its own memory, cache, and/or compute cores or other processing units. Different processing resources 108 may have different instance sizes. For example, the processing resource 108A may correspond to one-quarter of the host device 102 and the processing resource 108N may correspond to three-quarters of the host device 102 in one or more respects. By wa of example, and not limitation, the one or more respects may correspond, at least in part, to bandwidth allowances or capabilities over the interfaces 110. For example, the processing, resource 108A. May include one-quarter of the bandwidth allowance for the host d ice 102 and the processing resource 108N may include three-quarters of the bandwidth allowance for the host device 102. In various embodiments the processing resources 108 may include any number of processing resources partitioning the host device 102 and/or capabilities thereof in any suitable manner.

As a specific and non-limiting example, in at least one embodiment, the host device 102 is a GPU, the processing resources 108 each include one or more partitions of the GPU, the computing component 106 is a CPU, the interface 110 is a PCIe interface, and the bus 104 is a PCIe bus. While the host device 102, the interface 110, the computing component 106, and the bus 104 may refer to physical hardware, in one or more embodiments, one or more of those components may be at least partially virtualized.

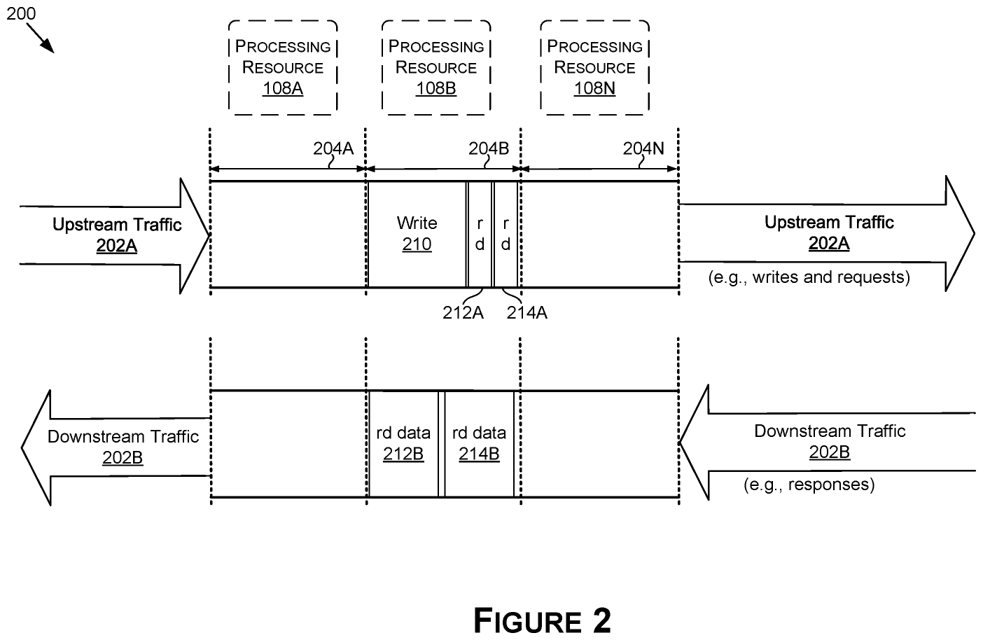

As described herein, the transaction monitor(s) 114 may be configured to analyze data corresponding to transactions for the processing resources 108 based at least on corresponding bandwidth allocations, so as to control the data on the bus(es) 104. For example, each processing resource 108 may have respective bandwidth allocations for upstream and/or downstream traffic over the bus(es) 104. The transaction monitor 114 may be configured to analyze data corresponding to transactions to and/or from the processing resource 108 so as to enforce the bandwidth allocation(s) for the processing resource 108. In at least one embodiment, the downstream and/or upstream bandwidth may be allocated for one or more particular time slots, examples of which are shown in FIG. 2. Referring now to FIG. 2, FIG. 2 illustrates an example of upstream and downstream bandwidth allocations 200 for a plurality of processing resources, in accordance with some embodiments of the present disclosure.

The upstream and downstream bandwidth allocations 200 correspond to upstream traffic 202A and downstream traffic 202B (also referred to as “traffic directions 202”) over the bus 104. As shown, the transaction monitor(s) 114 may be configured to divide the upstream traffic 202A and the downstream traffic 202B into time slots 204A, 204B, through 204N (also referred to as “time slots 204”). While the time slots 204 are shown as being shared for the upstream traffic 202A and the downstream traffic 202B, in at least one embodiment, different time slots may be used for the upstream traffic 202A and the downstream traffic 202B. Also, the time slots 204 may be of the same duration or of different durations with respect to one another.

In at least one embodiment, each time slot 204 corresponds to a respective processing resource 108. For example, the transaction monitor(s) 114 may assign the processing resource 108A the time slot 204A, may assign a processing resource 108B (not shown in FIG. 1) the time slot 204B, and may assign the processing resource 108N the time slot 204N. Further, the transaction monitor(s) 114 may track bandwidth consumption and/or enforce bandwidth allocations for a processing resource 108 with respect to a corresponding time slot 204. For example, the processing resource 108B may have an upstream bandwidth allocation for the time slot 204B and a downstream bandwidth allocation for the time slot 204B. The downstream bandwidth allocation may be the same as or different than the upstream bandwidth allocation. In embodiments where the processing resource 108B is for a partition of the host device 102, the bandwidth allocation(s) may be proportional to the size of the partition relative to the host device 102. For example, where the processing resources 108 shown in FIG. 2 each correspond to one-third of the host device 102, each processing resource 108 may be allocated one-third of the upstream and/or downstream bandwidth allocated to the host device 102.

The time slots 204 are shown in FIG. 2 as non-overlapping for simplicity but may be at least partially overlapping, as indicated by dashed lines. For example, one or more of the timeslots 204 may be implemented at least partially concurrently and/or may be shared by one or more of the processing resources 108. Thus, many different strategies may be used to share the bus(es) 104 between the processing resources 108, including, but not limited to, time-division, concurrent or processing resource shared-time slots, processing resource independent time slots, etc.

As a specific and not limiting example, the processing resource 108B may be allocated 256 Bytes for the upstream traffic 202A for the time slot 204B and 256 Bytes for the downstream traffic 202B for the time slot 204B. In at least one embodiment, the transaction monitor(s) 114 may track bandwidth consumption for the processing resources 108 using one or more values, such as counters. To track bandwidth consumption for a processing resource 108 the transaction monitor(s) 114 may receive data corresponding to a transaction from the processing resource 108, and analyze the data to update the one or more values to indicate the impact of the data on the bandwidth consumption. For example, a transaction monitor 114 may receive read request data 214A, and update the one or more values accordingly, receive read request data 212A and update the one or more values accordingly, and receive write data 210, and update the one or more values accordingly so as to iteratively and/or incrementally track bandwidth consumption for that data.

In at least one embodiment, the one or more values may correspond to one or more counters managed by the transaction monitor 114. A counter may be used to track bandwidth consumption for a particular processing resource 108, a particular time slot 204, and/or a particular traffic direction 202. For example, the transaction monitor 114 may use a counter(s) to track bandwidth consumption for the time slot 204B and the processing resource 108B, and the counter(s) may be reset or otherwise used for a subsequent time slot 204 for the processing resource 108B.

In some respects, a transaction monitor 114 uses the one or more values indicating the bandwidth consumption to filter or otherwise monitor transactions associated with the processing resource(s) 108 with respect to transmission over the bus(es) 104. For example, the transaction monitor 114 may permit and/or block transactions of a processing resource(s) 108 from being transmitted over the bus(es) 104 in a time slot(s) 204 so as to enforce the bandwidth allocation of the processing resource(s) 108 for the time slot(s) 204. This may include the transaction monitor 114 blocking one or more transactions from reaching the bus(es) 104 based at least on the counter exceeding a threshold value and/or permitting one or more transactions to be transmitted over the bus(es) 104 based at least on the counter exceeding a threshold value. For example, the transaction monitor 114 may analyze data associated with a transaction and determine the transaction would cause the counter to exceed a threshold value, and block the transaction based at least on the determination. Additionally or alternatively, the transaction monitor 114 may determine the counter has exceeded the threshold value, and block a transaction based at least on the determination.

In one or more embodiments, the transaction monitor 114 determines a transaction type of a transaction from a processing resource 108 (e.g., based at least on an analysis of data associated with the transaction). The transaction monitor 114 may update the one or more values indicating the bandwidth consumption for a time slot 204 based at least on the transaction type. By updating the one or more values based on a transaction type of a transaction, the transaction monitor 114 may more efficiently and effectively track and enforce upstream and/or downstream traffic allocations. Examples of transaction types include a read, a write, an atomic operation, and/or a particular category thereof (e.g., different levels of granularity may be used). A further example of a transaction type is a request versus a non-request, or a transaction that causes (or otherwise indicates) usage of downstream bandwidth versus a transaction that does not cause (or otherwise indicate) usage of downstream bandwidth.

For example, a write (e.g., corresponding to the write data 210) may only indicate usage of upstream traffic 202A, whereas a read (e.g., corresponding to the read request data 212A or the read request data 214A) may indicate usage of both upstream traffic 202A and downstream traffic 202B. In particular, the read request data 214A may indicate the usage of downstream traffic 202B for the read response data 214B (e.g., the data read and returned for the transaction), and the read request data 212A may indicate the usage of downstream traffic 202B for the read response data 212B. The transaction monitor 114 may update the one or more values used to track bandwidth usage based at least on whether a transaction indicates usage of downstream traffic. By way of example, and not limitation, based at least on a transaction indicating usage of downstream traffic, the transaction monitor 114 may update (e.g., increment) a counter used to track and enforce a downstream traffic allocation. The transaction monitor 114 may or may not also update (e.g., increment) a counter used to track and enforce an upstream traffic allocation based on the transaction. Additionally or alternatively, based at least on a transaction indicating no usage of downstream traffic, the transaction monitor 114 may update (e.g., increment) a counter used to track and enforce an upstream traffic allocation.

Thus, for example, using transaction types of messages, the transaction monitor 114 may block one or more additional transactions from the upstream traffic 202A that indicates usage of the downstream traffic 202B so as to enforce a downstream traffic allocation. However, the transaction monitor 114 may still permit one or more additional transactions to be transmitted over the bus(es) where the additional transaction(s) indicates no usage of the downstream traffic 202B. As an example, the write data 210 may be transmitted for the time slot 204B, but the transaction monitor 114 may block one or more additional reads (or atomic operations) for the time slot 204B based on determining the read would cause the downstream traffic allocation to be exceeded or where the downstream traffic allocation has already been exceeded.

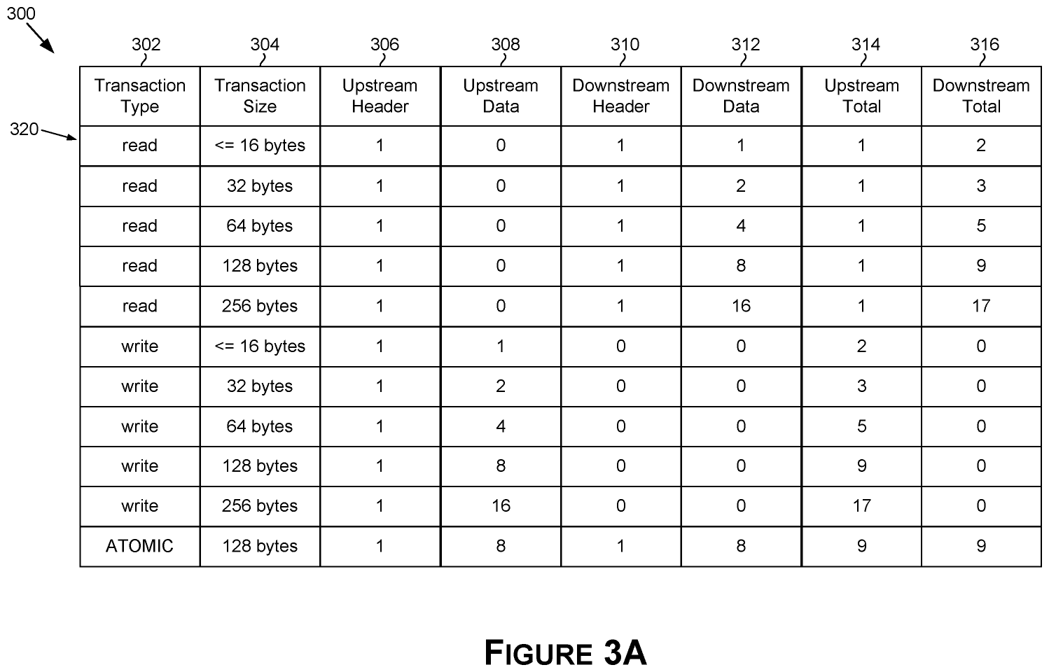

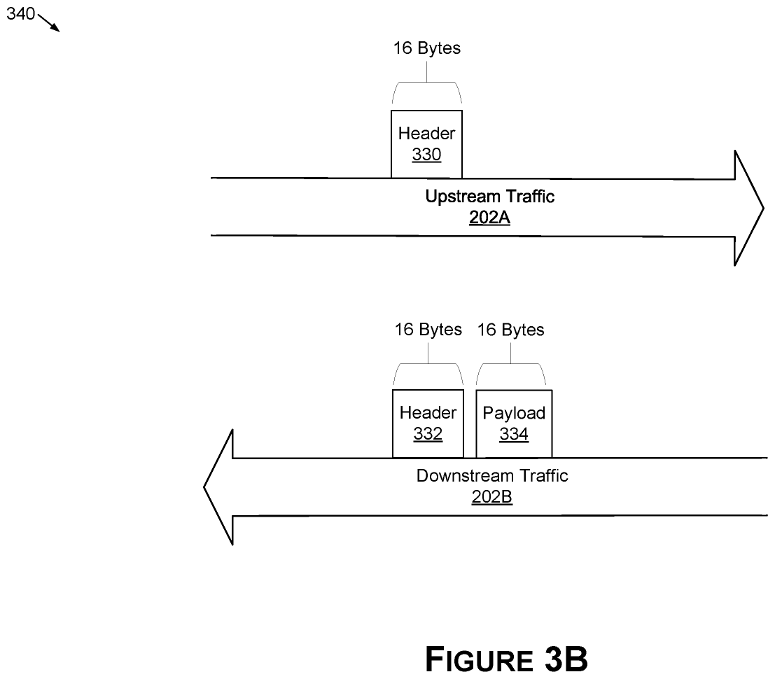

Additionally or alternatively, the transaction monitor 114 may determine a bandwidth usage or data size for a transaction from a processing resource 108 (e.g., based at least on an analysis of data associated with the transaction). The transaction monitor 114 may update the one or more values indicating the bandwidth consumption for a time slot 204 based at least on the bandwidth usage or data size. By updating the one or more values based on a data size of a transaction, the transaction monitor 114 may more efficiently and effectively track and enforce upstream and/or downstream traffic allocations. Referring now to FIG. 3A, FIG. 3A illustrates examples of amounts of bandwidth usage for various transactions, in accordance with some embodiments of the present disclosure. In particular, FIG. 3A shows a table 300, used to illustrate data a transaction monitor 114 may use to determine bandwidth usage for transactions, although other approaches may be used. For the example shown, at least some of the information shown in the table 300 may be indexed by transaction type 302 and transaction size 304, and used by the transaction monitor 114 to lookup a total upstream data size 314 and/or a total downstream data size 316 for a transaction.

The table 300 includes entries for an upstream header data size 306 and an upstream payload data size 308. As a non-limiting example, the entries indicate a number of chunks used for the transaction where each chunk is of the same transaction size 304 for the transaction type 302 (this may not always be the case in other embodiments). The total upstream data size 314 may be a sum of the upstream header data size 30 and the upstream payload data size 308. Similarly, the table 300 includes entries for a downstream header data size 310 and a downstream payload data size 312. The total downstream data size 316 may be a sum of the downstream header data size 310 and the downstream payload data size 312.

Referring now to FIG. 3B, FIG. 3B illustrates an example of upstream and downstream bandwidth usage for a transaction 340 corresponding to FIG. 3A, in accordance with some embodiments of the present disclosure. In particular, FIG. 3B may correspond to the transaction 340 matching a row 320 in FIG. 3A. As shown in FIG. 3B, the transaction 340 includes a header 330 that is 16 Bytes for the upstream traffic 202A, and includes a header 332 and a payload 334 that are each 16 Bytes for the downstream traffic 202B. Thus, a transaction monitor 114 may update one or more values indicating usage of the upstream traffic 202A by one chunk or other amount corresponding to (e.g., representing) 16 Bytes, and/or update one or more values indicating usage of the downstream traffic 202B by two chunks or other amount corresponding to (e.g., representing) 32 Bytes.

Where a transaction monitor 114 analyzes a message, the analysis may be performed on at least one or more portions of decoded packet data generated from one or more packets representing the transaction 340. For example, decode logic may generate one or more signals representing and/or indicating a transaction type, and the transaction monitor 114 may analyze the one or more signals. In various embodiments, the transaction monitor 114 may or may not perform the decoding (e.g., another component may perform the decoding). In at least one embodiment, the decoding is of packet or data size and type fields.

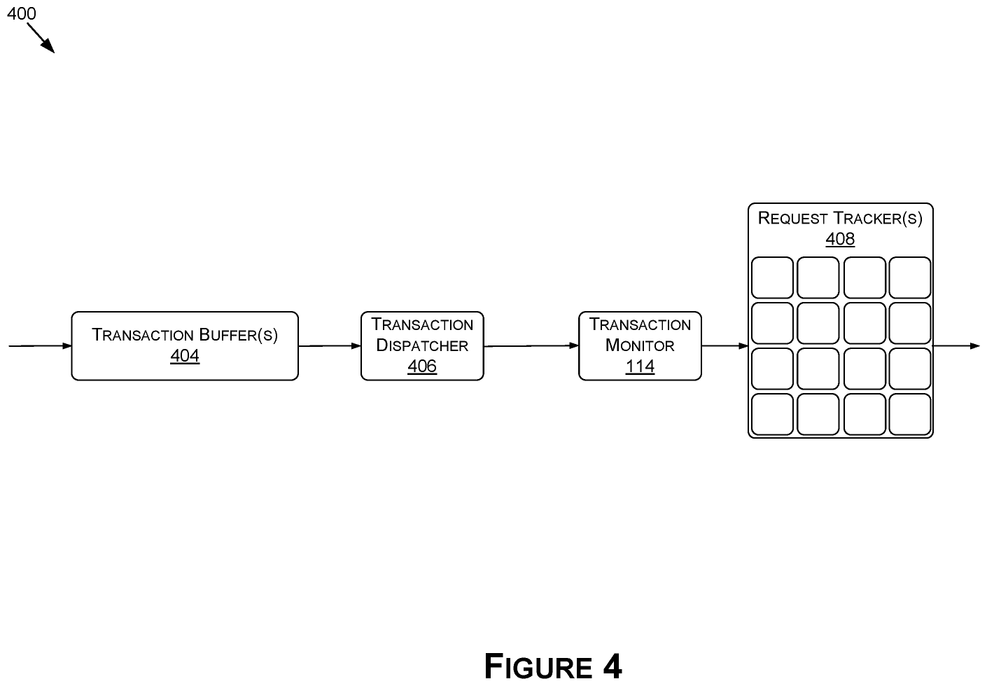

Referring now to FIG. 4, FIG. 4 is an illustration of an example of a transaction pipeline 400 that may be used for enforcing a bandwidth allocation to one or more processing resources, in accordance with some embodiments of the present disclosure. The transaction pipeline 400 may include, amongst other possible components, a transaction buffer(s) 404, a transaction dispatcher (TD) 406, a transaction monitor 114, and a request tracker(s) 408 (e.g., incorporated with an interface 110). In at least one embodiment, the transaction pipeline 400 may be at a component of the interface 110 that is configured to merge all requests from the host device 102. For example, in embodiments where the interface 110 includes a PCI-based interface, the transaction pipeline 400 may be at the high speed hub (HSHUB) of the interface 110.

In at least one embodiment, the transaction monitor 114 may be implemented using an initiator-ready/target-ready (irdy/trdy) transfer protocol wherein the transaction dispatcher (TD) 406 is configured to asserts irdy when the TD 406 has a transaction ready to transfer and the request tracker(s) (RT) 408 asserts trdy when the transaction is allowed to proceed. A transfer may occur based at least on irdy and trdy are both being asserted on a same cycle. This mechanism may be tuned so that a single transaction buffer 404 can saturate the interface 110 downstream.

Using an irdy/trdy transfer protocol is one potential approach for interceding between the TD 406 and the RT 408 in a way that can limit the transactions transferred over the transaction pipeline 400 for a prescribed period of time. However, other approaches and/or transaction pipelines may be used. In at least one embodiment, the transaction monitor 114 may be configured to opportunistically interfere with transfers between the TD 406 and the RT 408 in order to meet a certain number of transactions over a time slot 204 (e.g., a service period). To this effect, the transaction monitor 114 may use knowledge of the transaction type sent from the TD 406 to the RT 408, although it may do so without modifying the fields of the transaction.

The transaction buffer 404 may be configured to store transaction data until a transaction is dispatched using the transaction dispatcher 406. In at least one embodiment, the transaction buffer 404 is a transaction first-in, first-out, (FIFO) buffer. In at least one embodiment, each processing resource 108 may use the transaction buffer 404 exclusively, so any throttling applied to the transaction buffer by the transaction monitor 114 may only affect that processing resource 108.

By way of example, and not limitation, the transaction pipeline 400 may aim to limit a single transaction buffer 404 to no more than 10 GB/sec of bandwidth and to guarantee that bandwidth over a time slot 204 that is 1 μs. In the example of PCIe, this translates immediately to a solution in which the TD 406 is allowed to forward eighty 128B transactions (which may be programmable by configuration software) to the RT 408 every 1 us time slot. Assuming the transaction pipeline 400 is operating at 1.5 GHz, at the beginning of every 1500 cycle period (which may be programmable by configuration software), the TD 406 may have exactly eighty credits to work with. In embodiments where the transaction monitor 114 enforces bandwidth allocations independently for each time slot 204, the TD 406 may have exactly eighty credits to work with, no matter how many transactions it sent during the previous time slot 204.

However, in at least one embodiment, the TD 406 may allow excess bandwidth to be consumed by a processing resource 108 for a time slot 204. In such cases, the TD 406 may be configured to offset the credits and/or counter(s) for a subsequent time slot 204 by a corresponding amount(s). For example, if a processing resource 108 uses one or more additional credits above a threshold value, the threshold value may be reduced by the one or more credits for one or more subsequent time slots (e.g., the following time slot). Additionally or alternatively, if a processing resource 108 uses one or more credits less than the threshold value, the threshold value may be increased by the one or more credits for one or more subsequent time slots (e.g., the following time slot).

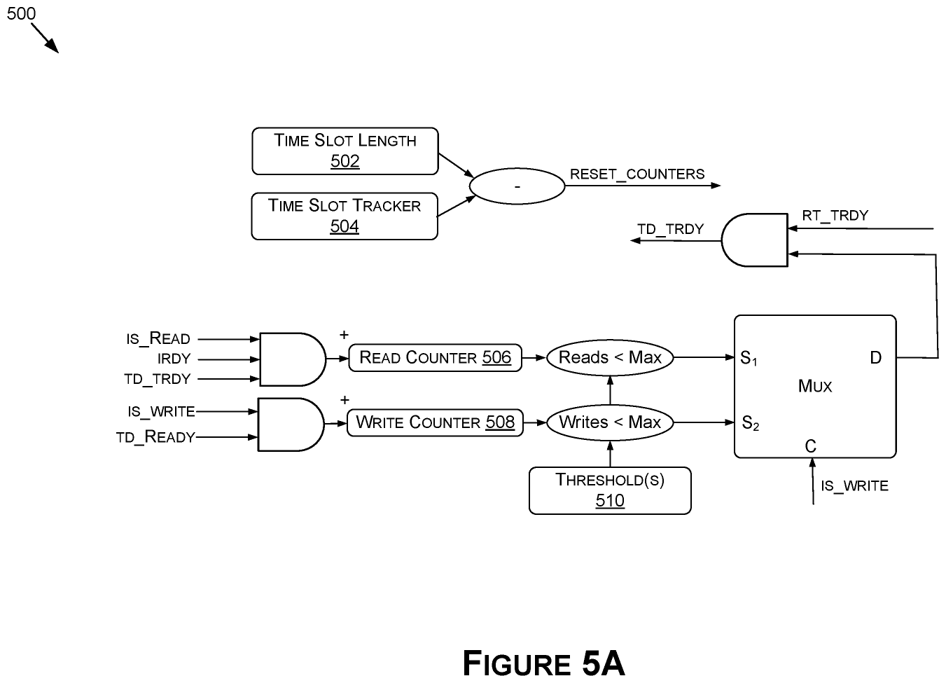

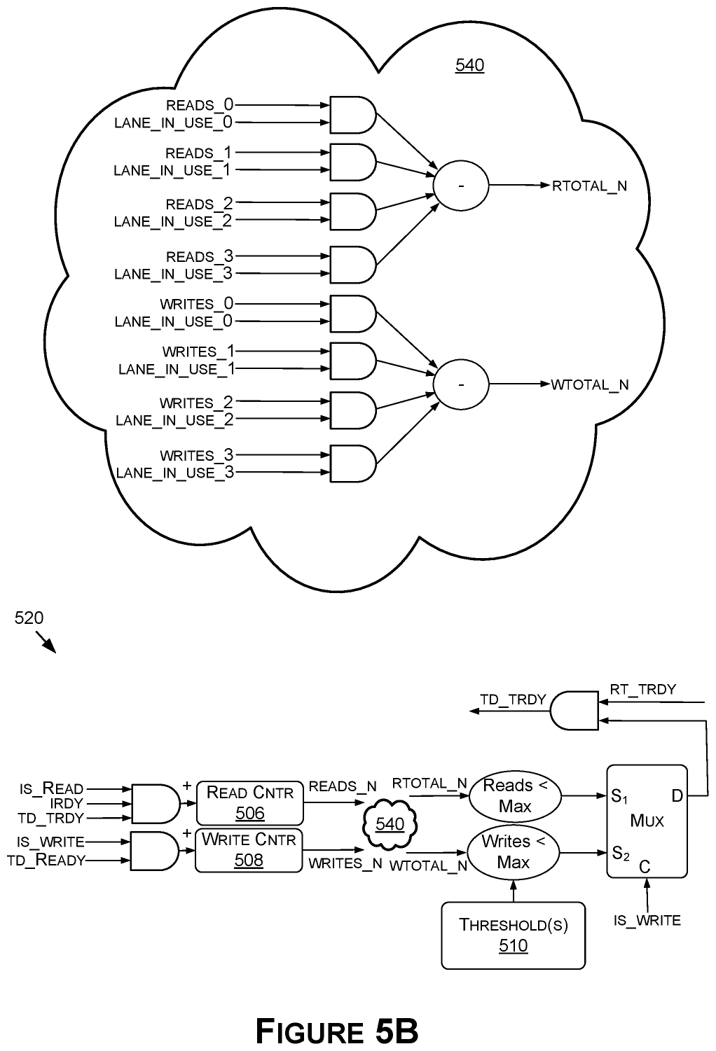

Referring now to FIG. 5A, FIG. 5A is an illustration of an example of a logic diagram which may be implemented to enforce bandwidth allocation for one or more processing resources, in accordance with some embodiments of the present disclosure. For example, FIG. 5A shows a logic diagram 500 which may be implemented in the transaction monitor 114 of FIG. 4. Amongst other components the logic diagram 500 includes a time slot length 502, a time slot tracker 504, a read counter(s) 506, a write counter(s) 508, and a threshold 510. The time slot length 502 may set the length of a time slot 204, such as 1500 cycles in the example above. The time slot tracker 504 may be used to track progress through the time slot 204 (e.g., the number of elapsed cycles), so that a RESET_COUNTERS signal is generated when the time slot 204 ends. The RESET_COUNTERS signal may cause the read counter 506 and the write counter 508 to be reset (e.g., to zero) for a subsequent time slot 204. The read counter 506 may be configured to track the total number of read transactions from a processing resource 108 for a time slot 204. The write counter 508 may be configured to track the total number of write transactions from the processing resource 108 for the time slot 204. The threshold(s) 510 may be used to set the threshold(s) used to enforce the bandwidth allocation(s) for the processing resource 108. In the example shown, the threshold(s) 510 provide a Max number of transactions for the time slot 204.

The is_read and is_write signals may indicate the transaction type of a transaction according to packet decode logic. An additional logic level may be included to the trdy signal coming from the RT 408 in order to create a td_rdy signal, as shown.

The approach of FIG. 5A uses transaction counters for limiting (e.g., capping) bandwidth for a transaction pipeline 400. However, as described herein, in some embodiments, the transaction pipeline 400 may account for different data sizes of transactions, even where the transactions are of the same type. This may be useful for interfaces 110, such as PCIe interfaces, that support various transaction sizes. In PCIe, 16-byte write transactions, for example, may occupy a 16-lane Gen6 interface for 250 ps, while a 256-byte write transaction may occupy the channel for 2125 ps. In this example, it may be assumed that each transaction has a footprint of 2125 ps so as to calculate the “max transactions” settings accordingly. Alternatively, setting the transaction cap for a typical (e.g., 128B) transaction may also be performed.

As a further example, the table 300 may be used, as described herein. For example, a decode of packet size and type fields may yield the number of 125 ps (16 byte) “chunks” required to send each type of packet. Thus, the logic diagram 500 may be updated accordingly. Using the non-limiting example described herein, limiting a time slot 204 to eighty 128B transactions (e.g., the threshold 510) to cap bandwidth at 10 GB/sec may be recalculated to seven-hundred and twenty to reflect the number of 16B chunks. As described herein, other systems may use other chunk sizes or have variable chunk sizes.

The approach described with respect to FIG. 5A may be used to enforce bandwidth allocations where each transaction buffer 404 is associated with its own processing resource 108. However, more than one transaction buffer 404, or lines, may be configured or grouped for a processing resource 108. For example, a processing resource 108 may connect to a plurality of send/receive lines of the interface 110. A line may refer to physical or virtual wire used to send and/or receive transaction data. For example, in PCIe, a lane may include a pair of wires, one for sending transaction data and one for receiving transaction data, and a PCIe slot may include one or more lanes.

In at least one embodiment, transaction pipelines may be configured such that bandwidth coming from different lines and/or lanes belonging to the same processing resource 108 can be shared. For example, a single processing resource 108 may use more than one line and/or lane so as to be capable of consuming the bandwidth allocation from all of its lines and/or lanes, even where only one line and/or lane is used. To do so, a transaction monitor 114 for one or more transaction pipelines may account for transactions from other transaction pipelines.

Referring now to FIG. 5B, FIG. 5B is an illustration of an example of a logic diagram 520 which may be implemented to enforce bandwidth allocation for one or more processing resources across a plurality of send and/or receive lines, in accordance with some embodiments of the present disclosure. The logic diagram 520 may be similar to the logic diagram 500 of FIG. 5A, which additional comparison logic 540, which may be used by multiple transaction monitors 114 of multiple transaction pipelines 400 to give a transaction monitor 114 a view of traffic for other transaction pipelines 400. The logic diagram 520 shows an example of the comparison logic 540 for four lanes, although any number of lanes and/or lines may be used. As indicated in FIG. 5B, a configurable mask may be used in the form of (lane_<n>_use_<neighbor>), where n refers to the lane number. For example, the configurable mask may correspond to lane_in_use_0, lane_in_use_1, lane_in_use_2, and lane_in_use_3. In FIG. 5A, rtotal_n may refer to the one or more read values compared to the one or more thresholds 510 for lane n, wtotal_n may refer to the one or more writes values compared to the one or more thresholds 510 for lane n, reads_n may refer to the total reads for lane n and a time slot 204, and writes_n may refer to the total writes for lane n and a time slot 204.

Assuming lane 2 and lane 3 are grouped into a processing resource 108, a mask configuration may be:
lane_0_use=0b0001 (lane0 is a solo)
lane_1_use=0b0010 (lane1 is a solo)
lane_2_use=0b1100 (lane2 and lane3 should be summed together)
lane_3_use=0b1100 (lane2 and lane3 should be summed together)
   and the threshold(s) 510 may be pooled together for lanes 2 and 3, reflecting the combined bandwidth allocation from the corresponding transaction pipelines 400. For example, lanes 2 and 3 may receive 160 collective transaction credits, whereas lanes 0 and 1 may each receive 80 individual transaction credits.

As described herein, the transaction monitor(s) 114 may be used to limit outbound or upstream traffic, which may be from a processing resource(s) 108. However, a computer component(s) 106 may still attempt to provide inbound, or downstream traffic, to the processing resource(s) 108. For example, a CPU-based driver may provide transactions, such as read or write transactions to a processing resource 108. In at least one embodiment, a transaction monitor(s) 114 may account for at least a portion of the traffic from (e.g., initiated by) a computing component 106 to a processing resource 108 in filtering and/or enforcing the outbound or upstream traffic from the processing resource 108. For example, the threshold(s) 510 (and/or the counter value(s)) may be adjusted (e.g., decreased) based at least on the inbound traffic. In at least one embodiment, the threshold(s) 510 (and/or the counter value(s)) may be adjusted in proportion to the number and/or data size of the inbound traffic. In one or more embodiments, the inbound traffic may count, at least in part, as outbound and/or inbound traffic generated by the processing resource 108. Additionally or alternatively, the inbound traffic may be used to credit, at least in part, outbound and/or inbound traffic that can be generated by or provided to one or more other processing resources 108. For example, the threshold(s) 510 may be adjusted (e.g., increased) for one or more other processing resources 108 (e.g., in proportion to the number and/or data size of the inbound traffic).

In at least one embodiment, traffic generated by a processing resource 108, such as PCIe traffic created by a GPU, may be referred to as outbound traffic. In at least one embodiment, traffic generated by a computing component 106, such as PCIe traffic created by a CPU, may be referred to as inbound traffic. In one or more embodiment, both inbound and outbound transactions may generate both upstream and downstream chunks.

In at least one embodiment, inbound traffic may be addressed, at least in part, using an address mapping between a computing component 106 and a processing resource 108, as part of determining in response to receiving a transaction from a computing component 106, which resources the computing component 106 is attempting to access for the transaction. For example, an HSHUB may determine the association between a CPU access and a MIG, through the address mapping that may be performed in order for the CPU accesses to find the resources they are trying to access. The allocation of memory address space to individual MIGs may be used for congestion avoidance. A vital side effect is that a CPU instruction that causes an access to the GPU memory or cache may be associated with an address that is “owned” by a certain MIG. Those accesses can be counted against the MIG's transaction or chunk allocation and can subsequently be used to reduce the MIG's allowable outgoing bandwidth for the next or a subsequent time slot(s). Other MIGs may then be allowed to use these extra chunks during the next or subsequent time slot(s), thus compensating for any bandwidth they may have missed out on due to aggressive CPU accesses during a previous time slot(s).

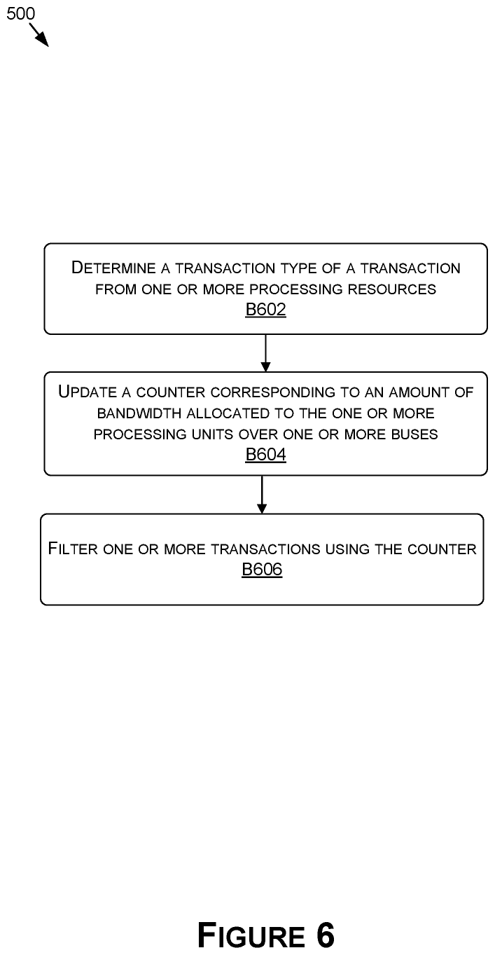

Now referring to FIG. 6, each block of method 600, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to particular figures. However, the methods may additionally or alternatively be executed by any one system, or any combination of systems, including, but not limited to, those described herein.

FIG. 6 is a flow diagram showing a method for enforcing a bandwidth allocation for a processing resource based on a transaction type, in accordance with some embodiments of the present disclosure. The method, at block B602, includes determining a transaction type of a transaction from one or more processing resources. For example, the transaction pipeline 400 may determine a transaction type of a transaction from one or more processing resources 108 of the processing resources 108 sharing the one or more buses 104.

The method, at block B604, includes updating a counter corresponding to an amount of bandwidth allocated to the one or more processing units over one or more buses. For example, the transaction monitor 114 may update a counter corresponding to an amount of bandwidth allocated to the one or more processing resources 108 over the one or more buses 104 for a time slot 204 based at least on the transaction being of the transaction type.

The method, at block B604, includes filtering one or more transactions using the counter. For example, the transaction monitor 114 may filter one or more transactions associated with the one or more processing resources 108 with respect to transmission over the one or more buses 104 using the counter (e.g., the transaction and/or one or more other transactions to or from the processing resource 108). In at least one embodiment, the filtering is based at least on the transaction monitor(s) 114 reducing an allocation of bandwidth to the one or more processing resources 108 for the time slot 204 in response to a determination (e.g., made by a transaction decoder) that incoming traffic from an entity is directed to the one or more processing resources 108.

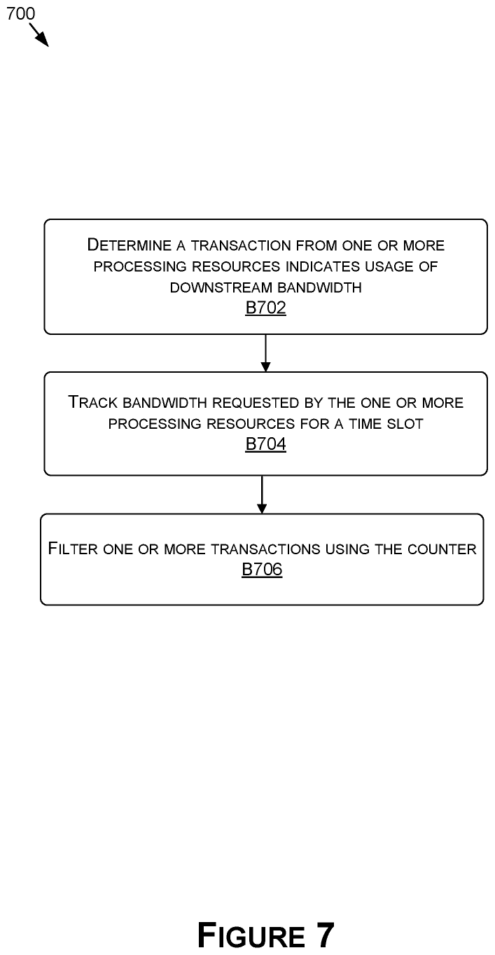

Referring now to FIG. 7, FIG. 7 is a flow diagram showing a method 700 for enforcing a bandwidth allocation for a processing resource based on a transaction indicating usage of downstream bandwidth, in accordance with some embodiments of the present disclosure;

The method 700, at block B702, includes determining a transaction from one or more processing resources indicates usage of downstream bandwidth. For example, the transaction monitor 114 may determine, based at least on an analysis of a transaction from one or more processing resources 108 of the processing resources 108 sharing the one or more buses 104, the transaction indicates usage of downstream bandwidth over the one or more buses 104.

The method 700, at block B704, includes tracking bandwidth requested by the one or more processing resources for a time slot. For example, the transaction monitor 114 may track an amount of bandwidth over the one or more buses 104 requested by the one or more processing resources 108 for a time slot 204 based at least on the transaction indicating usage of downstream bandwidth.

The method 700, at block B706, includes filtering one or more transactions associated with the one or more processing resources with respect to transmission over the one or more buses based at least on the amount of bandwidth. For example, the transaction monitor 114 may filter the transaction and/or one or more other transaction to or from the processing resource 108 based at least on the amount of bandwidth.

Example Computing Device

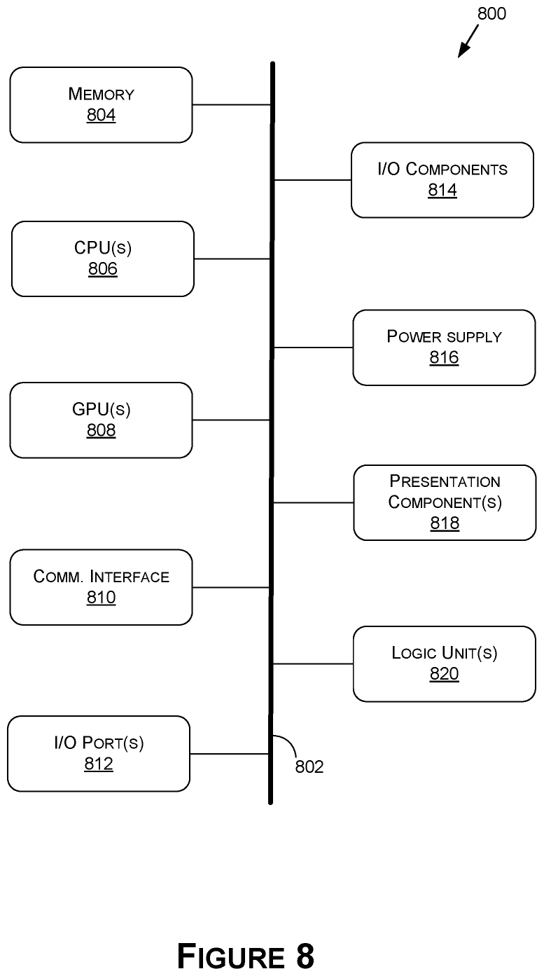

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

Example Data Center

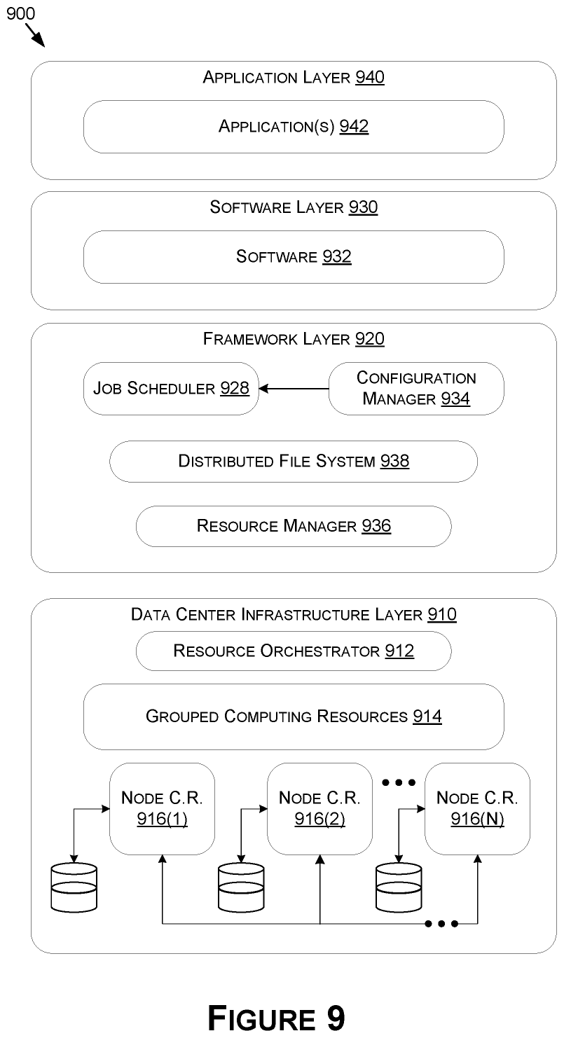

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining a transaction type of a transaction from one or more processing resources of a plurality of processing resources sharing one or more buses;
updating a counter corresponding to an amount of bandwidth allocated to the one or more processing resources over the one or more buses for a time slot based at least on the transaction being of the transaction type; and
filtering one or more transactions associated with the one or more processing resources with respect to transmission over the one or more buses using the counter.

2. The method of claim 1, wherein the counter corresponds to the amount of bandwidth downstream to the one or more processing resources.

3. The method of claim 1, further comprising determining a data size corresponding to the transaction, and the updating of the counter includes incrementing the counter by one or more values corresponding to the data size.

4. The method of claim 1, wherein the counter is a first counter corresponding to a first amount of downstream bandwidth allocated to the one or more processing resources for the time slot, and the method further includes updating a second counter corresponding to a second amount of upstream bandwidth allocated to the one or more processing resources for the time slot based at least on the transaction being of the transaction type.

5. The method of claim 1, wherein the counter corresponds to the amount of bandwidth downstream to the one or more processing resources, and the filtering includes:
permitting at least one transaction of the one or more transactions to be transmitted over the one or more buses based at least on the at least one transaction corresponding to a write operation.

6. The method of claim 1, comprising:
receiving decoded packet data generated from one or more packets representing the transaction; and
analyzing the decoded packet data to determine the transaction type.

7. The method of claim 1, wherein the one or more processing resources connect to a plurality of send and receive lines of a bus interface corresponding to the one or more busses, and the counter corresponds to the amount of bandwidth allocated to the one or more processing resources for the plurality of send and receive lines.

8. The method of claim 1, wherein the transaction type indicates a read operation or an atomic operation.

9. The method of claim 1, wherein the one or more buses correspond to a memory interface that is shared amongst the plurality of processing resources.

10. The method of claim 1, wherein the one or more processing resources are of one or more graphics processing units (GPUs) and the one or more buses connect the one or more GPUs to one or more central processing units (CPUs).

11. The method of claim 1, wherein the filtering includes blocking the one or more transactions from reaching the one or more buses based at least on the counter exceeding a threshold value.

12. A system comprising:
one or more circuits to perform operations including:
determining, based at least on an analysis of a transaction from one or more processing resources of a plurality of processing resources sharing one or more buses, the transaction indicates usage of downstream bandwidth over the one or more buses;
tracking an amount of bandwidth over the one or more buses requested by the one or more processing resources for a time slot based at least on the transaction indicating usage of downstream bandwidth; and
filtering one or more transactions associated with the one or more processing resources with respect to transmission over the one or more buses based at least on the tracking.

13. The system of claim 12, wherein the one or more circuits are situated between one or more transaction dispatchers of an interface to the one or more buses, and one or more request trackers of the interface.

14. The system of claim 12, wherein the operations include associating a transaction type with the transaction based at least on the analysis, and the determining the transaction indicates usage of downstream bandwidth is based at least on the transaction type.

15. The system of claim 12, wherein the tracking is based at least on updating a counter indicating the amount of bandwidth requested by the one or more processing resources, and the filtering is based at least on comparing one or more values of the counter to one or more threshold values.

16. The system of claim 12, wherein the counter is a first counter used to track downstream bandwidth requested by the one or more processing resources for the time slot, the operations further include updating a second counter used to track upstream bandwidth requested by the one or more processing resources for the time slot, and the filtering uses the first counter and the second counter.

17. The system of claim 12, wherein the operations include determining a data size corresponding to the transaction, and the tracking of the amount of bandwidth is based at least on the data size.

18. The system of claim 12, wherein the filtering is based at least on reducing an allocation of bandwidth to the one or more processing resources for the time slot in response to a determination that incoming traffic from an entity is directed to the one or more processing resources.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

20. A processor comprising:
one or more circuits to enforce an amount of bandwidth allocated to one or more processing resources over one or more buses for a time slot based at least on a transaction type of a transaction from the one or more processing resources, wherein the one or more processing resources are of a plurality of processing resources sharing the one or more buses.

21. The processor of claim 20, wherein the time slot is a first time slot, and the amount of bandwidth allocated to the one or more processing resources over the one or more buses for a second time slot is reduced based at least on the one or more processing resources exceeding the amount of bandwidth in the first time slot.

22. The processor of claim 20, wherein the amount of bandwidth is a first amount of downstream bandwidth allocated to the one or more processing resources for the time slot, and the one or more circuits are further to enforce a second amount of upstream bandwidth allocated to the one or more processing resources for the time slot based at least on the transaction type.

23. The processor of claim 20, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
